(19) United States
(12) Patent Application Publication
(10) Pub. No.: US 2007/0186984 A1
(43) Pub. Date: Aug. 16, 2007

(54) LIQUID CONTAINER

(76) Inventor: Hitotoshi Kimura, Matsumoto-shi (JP)

Correspondence Address: STROOCK & STROOCK & LAVAN LLP, 180 MAIDEN LANE, NEW YORK, NY, 10038, US

(21) Appl. No.: 11/675,244

(22) Filed: Feb. 15, 2007

(30) Foreign Application Priority Data
Feb. 15, 2006 (JP) P2006-038577

(51) Int. Cl. F16K 24/00

(52) U.S. Cl. 137/588

(57) ABSTRACT

A liquid container includes: a liquid containing chamber that discharges a liquid stored therein by pressurization of a pressure unit; a liquid detection chamber that is connected to the liquid containing chamber, and the volume of which changes according to an inflow amount of the liquid from the liquid containing chamber; a detection unit for detecting a change of the volume of the liquid detection chamber; and a valve mechanism that is disposed between the liquid containing chamber and the liquid detection chamber and that can block an inflow of the liquid from the liquid containing chamber to the liquid detection chamber.

### BACKGROUND

1. Technical Field

The present invention relates to a liquid container, and in particular, to a liquid container that supplies a liquid, such as ink or the like, to a liquid consuming apparatus, for example, a liquid jetting head ejecting a minute amount of liquid droplet.

2. Related Art

A liquid jetting head of a textile printing apparatus, a micro dispenser, or a commercial recording apparatus that requires ultrahigh printing quality receives a liquid ejected from a liquid container that is detachably mounted on an apparatus main body. However, in order to prevent the liquid jetting head from being damaged due to idle printing, it is necessary to monitor a liquid residual quantity in the container.

For example, there are suggested various methods that detects an ink residual quantity of an ink cartridge as a liquid container used in a recording apparatus. In an ink cartridge that discharges ink by a pressure of a pressurized fluid, typically air, to be supplied from the outside, as disclosed in Patent Document 1, there is known a method that attaches an electrode to face an ink pouch formed of a flexible material containing ink and detects the thickness of an ink. Further, as disclosed in Patent Document 2, there is known a method that forms a hole in a flow passage connecting an ink pouch and an ink supply port, fixes a pressure sensor to seal the hole, and detects a discharge pressure using the pressure sensor.

Patent Document 1: U.S. Pat. No. 6,151,039 (specification)

Patent Document 2: U.S. Pat. No. 6,435,638 (specification)

As described above, in order to prevent a liquid consuming apparatus (jetting head) from being damaged due to idle printing, a liquid residual quantity in the container is monitored by various methods.

However, in the known liquid container, residual bubbles are dissolved in ink having a high degree of deaeration, but a structure for improving a bubble discharge property is not provided. Accordingly, when the amount of bubbles is large, bubbles that are not dissolved in ink may appear.

The minute bubbles may drift with ink and be stuck to a sensor surface of an ink residual quantity detection unit. For this reason, detection accuracy of presence/absence of ink may be lowered. Further, if the bubbles may enter the jetting head, a pressure for ejecting ink droplets may be absorbed due to the bubbles, that is, defective printing may be caused. At the worst, idle printing may be caused, and the jetting head may be damaged.

Meanwhile, in the liquid container, there may be a case where, before shipping after ink filling, bubbles existing in an internal flow passage from a liquid containing chamber to an ink supply port are excluded through suction of ink from the ink supply port. In this case, however, as described above, since the structure for improving the bubble discharge property is not provided, it is difficult to reliably discharge the bubbles.

### SUMMARY

An advantage of some aspects of the invention is to provide a liquid container that can increase a bubble discharge effect. The advantage can be attained as at least one of the following aspects:

An aspect of the invention provides a liquid container comprising: a liquid containing chamber that discharges a liquid stored therein by pressurization of a pressure unit; a liquid detection chamber that is connected to the liquid containing chamber, and the volume of which changes according to an inflow amount of the liquid from the liquid containing chamber; a detection unit for detecting a change of the volume of the liquid detection chamber; and a valve mechanism that is disposed between the liquid containing chamber and the liquid detection chamber and that can block an inflow of the liquid from the liquid containing chamber to the liquid detection chamber.

According to this configuration, the inflow of ink from the liquid containing chamber to the liquid detection chamber is blocked by the valve mechanism. Further, if the liquid is absorbed from the supply port, the liquid detection chamber is in a negative pressure state, and minute bubbles existing in the liquid detection chamber are swelled, and have a large volume.

Accordingly, resistance of a flow of the liquid to be discharged from the supply port becomes large, and the bubbles are easily transferred along with the liquid that flows toward the supply port.

In the liquid container according to the aspect of the invention, the valve mechanism may include a valve chamber that communicates an inlet port communicating with the liquid containing chamber with an outlet port communicating with the liquid detection chamber, and a diaphragm that defines the valve chamber and is deformable by an external force. The outlet port that is formed in the valve chamber may be closed by deformation of the diaphragm.

According to this configuration, the diaphragm can be easily deformedby causing the external force to act on the diaphragm. Accordingly, the diaphragm comes into close contact with the outlet port formed in the valve chamber by the deformed diaphragm and the negative pressure of the liquid detection chamber through the suction of the liquid from the supply port. Therefore, the outlet port can be reliably closed.

In the liquid container according to the aspect of the invention, the valve mechanism may be disposed in a region that is isolated from a pressure of the pressure unit, and the outlet port formed in the valve chamber may be closed by the deformation of the diaphragm according to a negative pressure of the valve chamber generated through suction of the liquid from a liquid supply port.

According to this configuration, the pressure applied to the liquid containing chamber by the pressure unit does not act on the valve mechanism. Accordingly, the outlet port can be closed by setting the valve chamber communicating with the liquid detection chamber through the outlet port to the negative pressure and causing the diaphragm to be deformed by the negative pressure. That is, it is unnecessary to separately provide a mechanism for applying the external force in the diaphragm, and thus the valve mechanism can be simply configured.

In the liquid container according to the aspect of the invention, the outlet port that is formed in the valve chamber may have an area larger than that of the inlet port that is formed in the valve chamber.

According to this configuration, a large suction force acts on the valve chamber. Accordingly, the valve chamber is in the negative pressure state, and thus the suction of the diaphragm is reliably performed. That is, the outlet port can be reliably closed.

In the liquid container according to the aspect of the invention, the outlet port that is formed in the valve chamber may be disposed to face a maximum displacement portion of the diaphragm.

According to this configuration, since the outlet port is disposed to face the maximum displacement portion of the diaphragm, the outlet port can be reliably closed at a small negative pressure. Further, since a distance between the outlet port and the diaphragm can be set to be long in a normal state, flow passage resistance in that region can be made small.

In the liquid container according to the aspect of the invention, the liquid detection chamber may be configured by sealing an opening of a concave space provided in a member forming the liquid detection chamber with a film that is deformable according to a liquid containing amount.

According to this configuration, the liquid detection chamber can be formed by a simple manufacturing process of sealing the opening of the concave space with the film through thermal welding. Therefore, an airtight liquid detection chamber can be easily manufactured.

In the liquid container according to the aspect of the invention, the diaphragm may be formed of a deformable film that seals an opening of a concave place provided in a member forming the valve chamber.

According to this configuration, the valve chamber can be formed by a simple manufacturing process of sealing the opening of the concave place with the film through thermal welding. Therefore, an airtight valve chamber can be easily manufactured.

In the liquid container according to the aspect of the invention, the detection unit may include a moving member that is accommodated to move according to the liquid containing amount of the liquid detection chamber, a concave portion that, if the liquid containing amount of the liquid detection chamber becomes a predetermined amount or less, defines a detection space in cooperation with a surface of the moving member, and a piezoelectric detection unit that applies vibration to the concave portion and detects a free vibration state according to the applied vibration.

According to this configuration, if the liquid containing amount in the liquid detection chamber becomes a predetermined amount or less, the moving member defines the detection space in cooperation with the concave portion serving as a vibration reaction region. Accordingly, a change of the free vibration state markedly appears, and thus a time or state where the liquid containing amount in the liquid detection chamber reaches a predetermined level can be accurately and reliably detected.

In the liquid container according to the aspect of the invention, the valve mechanism that is disposed between the liquid containing chamber and the liquid detection chamber so as to block the inflow of the liquid from the liquid containing chamber to the liquid detection chamber. Accordingly, the in flow of the liquid from the liquid containing chamber to the liquid detection chamber is blocked, and the liquid detection chamber is in the negative pressure through the suction of the liquid from the supply port. Therefore, the minute bubbles existing in the liquid detection chamber can be swelled and have a large volume.

Accordingly, resistance against the bubbles by the flow of the liquid to be discharged from the supply port can increase, and the bubbles can be easily transferred along with the liquid that flows toward the supply port. Further, in a state where the minute bubbles are swelled, if the liquid for normal bubble discharge is absorbed from the supply port (the inflow of the liquid from the liquid containing chamber), a liquid discharge amount increases, and thus a bubble discharge effect can be further improved. As a result, the bubbles existing in the liquid detection chamber can be reliably discharged.

The present disclosure relates to the subject matter contained in Japanese patent application No. 2006-038577 filed on Feb. 15, 2006, which is expressly incorporated herein by reference in its entirety.

### BRIEF DESCRIPTION OF THE DRAWINGS

The invention will be described with reference to the accompanying drawings, wherein like numbers reference like elements.

FIG. 1 is a longitudinal cross-sectional view of a liquid container according to a first embodiment of the invention.

FIG. 2 is a longitudinal cross-sectional view of the liquid container shown in FIG. 1 in a state where an inlet port and an output port are closed.

FIG. 3 is a longitudinal cross-sectional view of the liquid container in a state where a pressure chamber is pressurized by a pressure unit.

FIG. 4 is a longitudinal cross-sectional view of a liquid container according to a second embodiment of the invention.

### DESCRIPTION OF EXEMPLARY EMBODIMENTS

Hereinafter, preferred embodiments of a liquid container according to the invention will be described in detail with reference to the accompanying drawings.

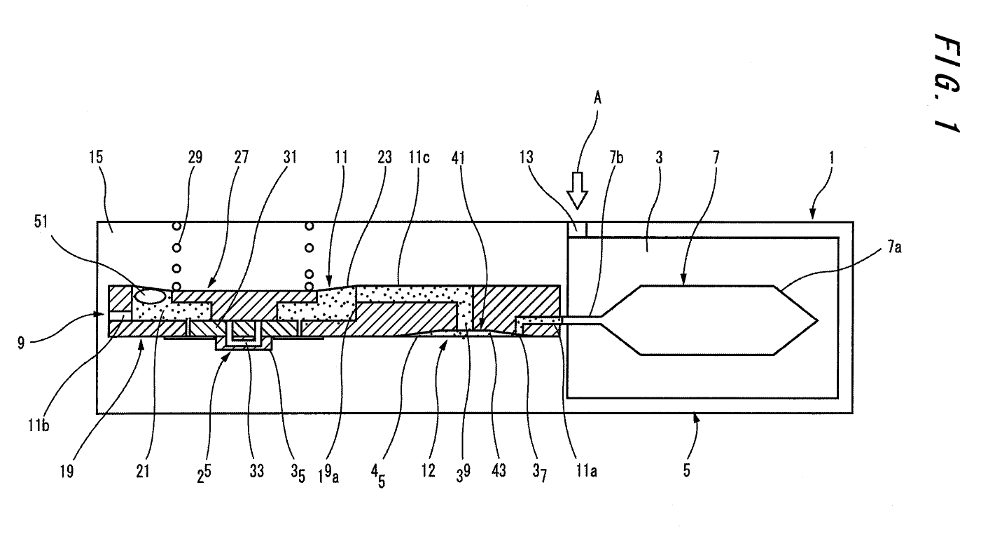

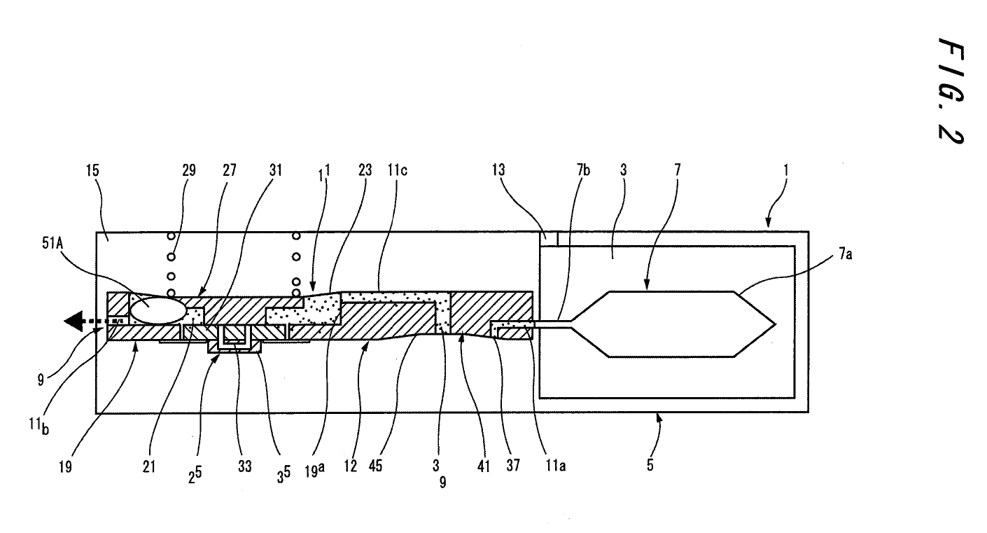

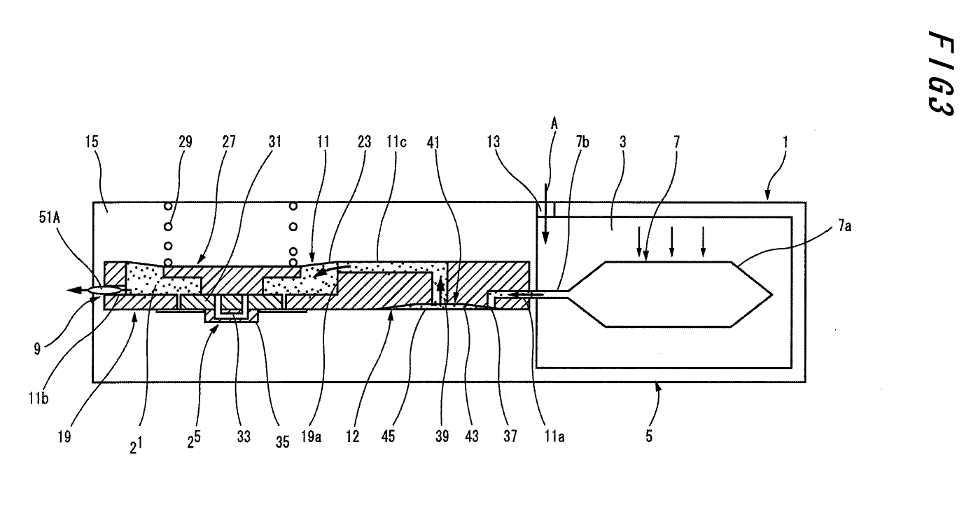

FIG. 1 is a longitudinal cross-sectional view of a liquid container according to a first embodiment of the invention in a state where a liquid containing amount of a liquid detection chamber becomes a predetermined amount or less. FIG. 2 is a longitudinal cross-sectional view of the liquid container shown in FIG. 1 in a state where an inlet port and an outlet port are closed. FIG. 3 is a longitudinal cross-sectional view of the liquid container in a state where a pressure chamber is pressurized by a pressure unit.

A liquid container 1 according to the first embodiment is an ink cartridge that is detachably mounted on a cartridge mounting portion of an ink jet recording apparatus (not shown) and supplies ink (liquid) to a printing head provided in the recording apparatus.

As shown in FIG. 1, the liquid container 1 includes a container main body 5 that defines a pressure chamber 3 to be pressurized by a pressure unit (not shown), an ink pack (liquid containing chamber) 7 that stores ink, is accommodated in the pressure chamber 3, and discharges ink stored therein from a discharge port (liquid discharge port) 7b by pressure of the pressure chamber 3, a liquid supply port (supply port) 9 that supplies ink to a printing head of an ink jet recording apparatus as an external liquid consuming apparatus, an ink detection unit (detection unit) 11 that is interposed between the ink pack 7 and the ink supply port 9 so as to detect an ink residual quantity, and an on/off valve mechanism 12 that is disposed between the ink pack 7 and the ink detection unit 11 so as to block an inflow of ink from the ink pack 7 to the ink detection unit 11.

The container main body 5 has the airtight pressure chamber 3, a pressure port 13 serving as a pressurized gas injection portion, through which the pressure unit (not shown) supplies pressurized air to the pressure chamber 3 as indicated by an arrow A, and a detection unit accommodating chamber 15 that accommodates the ink detection unit 11.

The detection unit containing chamber 15 is a region that is isolated from the pressure of the pressurized gas to be supplied to the pressure chamber 3. Accordingly, the pressure applied from the pressure unit does not act on a sensor chamber 21, and thus the pressure of the pressurized gas does not act on the ink detection unit 11 and the on/off valve mechanism 12 provided in the sensor chamber 21.

The ink pack 7 has a flexible pouch body 7a formed by adhering edges of aluminum-laminated multilayer films, on which an aluminum layer is laminated on a flexible resin film, to each other. A cylindrical discharge port 7b, to which an ink inlet port (liquid inlet port) 11a of the ink detection unit 11 is connected, is bonded to one end of the pouch body 7a. Since the ink pack 7 uses the aluminum-laminated multilayer films, a high gas barrier property is secured.

The ink pack 7 and the ink detection unit 11 are connected to each other by engaging the ink inlet port 11a with the discharge port 7b. That is, the ink pack 7 and the ink detection unit 11 can be detached from each other by releasing the engagement of the discharge port 7b and the ink inlet port 11a.

Moreover, in the discharge port 7b, a packing that connects the discharge port 7b and the ink inlet port 11a airtight is provided. Then, ink is filled into the ink pack 7 in advance at a high degree of deaeration before the ink detection unit 11 is connected.

The ink detection unit 11 includes a detection unit case 19 that has a concave space 19a communicating the ink inlet port 11a connected to the discharge port 7b of the ink pack 7 and an ink outlet port (liquid outlet port) 11b connected to the ink supply port 9, a flexible film 23 that seals an opening of the concave space 19a so as to define a sensor chamber (liquid detection chamber) 21, a pressure detection unit 25 that is provided at the bottom of the concave space 19a, a pressure receiving plate (moving member) 27 that is fixed to the flexible film 23 to face the pressure detection unit 25, and a compressed coil spring (urging unit) 29 that is compressed between the pressure receiving plate 27 and a top wall of the detection unit accommodating portion 15 and elastically urges the pressure receiving plate 27 and the flexible film 23 in a direction in which the volume of the sensor chamber 21 is reduced.

The sensor chamber 21 is preferably configured by sealing the opening of the concave space 19a provided in the detection unit case 19 as a member forming the sensor chamber 21 with the flexible film 23. The flexible film 23 functions as a diaphragm that applies displacement to the pressure receiving plate 27 according to the pressure of ink to be supplied to the sensor chamber 21. In order to enable detection of a minute change of pressure of ink and to improve detection accuracy, what is necessary is that the flexible film 23 has enough flexibility. With this configuration, the sensor chamber 21 can be formed by a simple manufacturing process of sealing the opening of the concave space 19a with the flexible film 23 using thermal welding. Accordingly, the airtight sensor chamber 21 can be easily manufactured.

In the detection unit case 19, an ink discharge path 11c is integrally formed at one end of a peripheral wall defining the concave space 19a, and the ink outlet port 11b that communicates with the ink supply port 9 is formed to pass through a peripheral wall facing the ink discharge path 11c. Though not shown, a valve mechanism is provided in the ink supply port 9. The valve mechanism opens a flow passage when the ink cartridge is mounted on the cartridge mounting portion of the ink jet recording apparatus and an ink supply needle provided in the cartridge mounting portion is inserted into the ink supply port 9.

The pressure detection unit 25 of the ink detection unit 11 includes a bottom plate 31 that comes into close contact with the pressure receiving plate 27 by an urging force of the compressed coil spring 29 when ink is not deduced from the ink pack 7 to the ink supply port 9, an ink guide path 33 that is a concave portion formed in the bottom plate 31, and a piezoelectric sensor (piezoelectric detection unit) 35 that applies vibration to the ink guide path 33 and detects a free vibration state according to the applied vibration.

The piezoelectric sensor 35 can detect different free vibration states (amplitude of residual vibration or change of frequency) according to whether or not the ink guide path 33 is covered with the pressure receiving plate 27.

Accordingly, for example, a control unit provided in the inkjet recording apparatus can detect deformation of the flexible film 23 supporting the pressure receiving plate 27 according to the free vibration state detected by the piezoelectric sensor 35, thereby detecting a change of the volume of the sensor chamber 21.

An urging direction of the compressed coil spring 29 is a direction in which the volume of the sensor chamber 21 is reduced, as described above, and a direction in which the piezoelectric sensor 35 is disposed.

The ink guide path 33, which is the concave portion formed in the bottom plate 31, defines a detection space in cooperation with the pressure receiving plate 27 in a state where the pressure receiving plate 27 comes into close contact with the bottom plate 31, as shown in FIG. 1. Further, in a state where the pressure receiving plate 27 is separated from the bottom plate 31, the ink guide path 33 is opened and communicates with the sensor chamber 21. The pressure receiving plate 27 has, in a region facing a vibration surface of the piezoelectric sensor 35, a surface substantially parallel to the vibration surface.

In the ink detection unit 11, if ink is supplied from the ink pack 7 to the sensor chamber 21 by pressurization of the ink pack 7 due to pressurized air to be supplied to the pressure chamber 3, the flexible film 23 is deformed to be swelled upward corresponding to a change of ink containing amount of the sensor chamber 21. With the deformation of the flexible film 23, the pressure receiving plate 27 that constitutes a part of a define wall of the sensor chamber 21 moves upward, and the pressure receiving plate 27 is separated from the bottom plate 31. If the pressure receiving plate 27 is separated from the bottom plate 31, the ink guide path 33 is opened and communicates with the sensor chamber 21, and thus ink is supplied from the ink supply port 9 to the recording head through the sensor chamber 21.

Even if the pressure chamber 3 is in a predetermined pressurization state, when ink contained in the ink pack 7 decreases, the amount of ink to be supplied from the ink pack 7 to the sensor chamber 21 decreases. Then, since the pressure of the sensor chamber 21 decreases, the pressure receiving plate 27 approaches the bottom plate 31 having the ink guide path 33.

That is, if the liquid containing amount in the sensor chamber 21 is a predetermined amount or less, the pressure receiving plate 27 defines the detection space in cooperation with the ink guide path 33 as a vibration reaction region. Accordingly, a change of free vibration state to be detected by the piezoelectric sensor 35 markedly appears, and thus a time or state where the liquid containing amount in the sensor chamber 21 reaches a predetermined level can be accurately and reliably detected. In this embodiment, a time at which the pressure receiving plate 27 comes into close contact with the bottom plate 31 by the decrease in pressure of the sensor chamber 21 and defines the detection space in cooperation with the ink guide path 33 is set to a state where ink of the ink pack 7 is exhausted.

The on/off valve mechanism 12 is disposed between the ink pack 7 and the ink detection unit 11 and blocks the inflow of ink from the ink pack 7 to the ink detection unit 11. The on/off valve mechanism 12 has a valve chamber 41 that causes an inlet port 37 communicating with the ink pack 7 to communicate with an outlet port 39 communicating with the sensor chamber 21.

The valve chamber 41 is configured by sealing an opening of a concave place 43 provided in the detection unit case 19 as a member forming the valve chamber 41 with a diaphragm 45. With this configuration, the valve chamber 41 can be formed by a simple manufacturing process of sealing the opening of the concave place 43 with the diaphragm 45 through thermal welding. Accordingly, the airtight valve chamber 41 can be easily manufactured.

The diaphragm 45 is formed of a deformable film (flexible member). The outlet port 39 formed in the valve chamber 41 can be closed by the deformation (close adhesion) of the diaphragm 45.

In this embodiment, the outlet port 39 formed in the valve chamber 41 is closed by the deformation of the diaphragm 45 due to a negative pressure of the valve chamber 41 generated through the suction of ink from the ink supply port 9. That is, the outlet port 39 can be closed by setting the valve chamber 41 communicating with the sensor chamber 21 through the outlet port 39 to have a negative pressure by ink of the sensor chamber 21 to be absorbed from the ink supply port 9 and causing the diaphragm 45 to be deformed by the negative pressure.

Specifically, it is unnecessary to separately provide a mechanism for applying an external force in the diaphragm 45, and thus the on/off valve mechanism 12 can be simply configured.

The outlet port 39 formed in the valve chamber 41 has preferably an area larger than that of the inlet port 37 formed in the valve chamber 41. Accordingly, a large suction force acts on the valve chamber 41. Therefore, the valve chamber 41 is set to the negative pressure, and thus the suction of the diaphragm 45 is reliably performed, that is, the outlet port 39 can be reliably closed.

The outlet port 39 formed in the valve chamber 41 is disposed to face a maximum displacement portion of the diaphragm 45 (a central portion of the diaphragm 45). Accordingly, the diaphragm 45 can be reliably displaced at a small negative pressure, and the outlet port 39 can be reliably closed. Further, since a distance between the outlet port 39 and the diaphragm 45 can be set to be long in a normal state, flow passage resistance in that region can be made small.

In the liquid container 1, when the ink containing amount (liquid containing amount) of the sensor chamber 21 is a predetermined amount or less, the pressure receiving plate 27 defines the detection space serving as the vibration reaction region in cooperation with the ink guide path 33. Accordingly, a frequency of acoustic impedance corresponding to the ink guide path 33 appears. This frequency becomes lower than a frequency by acoustic impedance when the pressure receiving plate 27 is separated from the bottom plate 31, and a difference markedly appears. For this reason, the change of free vibration state to be detectedby the piezoelectric sensor 35 markedly appears. Therefore, the time or state where the ink containing amount in the sensor chamber 21 reaches the predetermined level can be accurately and reliably detected.

In the liquid container 1 of this embodiment, the sensor chamber 21 is configured by sealing the opening formed at the top surface with the flexible film 23 that is deformable according to the ink containing amount. Further, the piezoelectric sensor 35 is disposed at the bottom of the sensor chamber 21.

For this reason, the sensor chamber 21 can be easily deformed corresponding to the change of the ink containing amount (change of pressure), and can be easily formed as an airtight space. Therefore, liquid leakage or heat generation can be prevented by a simple structure.

In the liquid container 1 of this embodiment, the pressure receiving plate 27 is fixed to the flexible film 23, and moves by the deformation of the flexible film 23 corresponding to the change of the ink containing amount of the sensor chamber 21. For this reason, with the easy deformation of the flexible film 23, the pressure receiving plate 27 can smoothly follow the liquid level or the pressure.

In the liquid container 1 of this embodiment, the pressure receiving plate 27 has, in the region facing the vibration surface of the piezoelectric sensor 35, the surface substantially parallel to the vibration surface. Therefore, the detection space, the volume of which varies according to the liquid level, can be easily formed.

In the liquid container 1 of this embodiment, the pressure receiving plate 27 is urged in the direction, in which the piezoelectric sensor 35 is disposed, by the compressed coil spring 29 serving as an urging unit formed of an elastic member. For this reason, by adjusting the urging force of the compressed coil spring 29, a time at which the pressure receiving plate 27 defines the detection space in cooperation with the ink guide path 33, can be arbitrarily changed. Therefore, an internal pressure (liquid residual quantity) of the sensor chamber 21 to be detected can be easily set.

In the liquid container 1 of this embodiment, the time at which the pressure receiving plate 27 defines the detection space in cooperation with the ink guide path 33 is set to a state where ink of the ink pack 7 is exhausted. Accordingly, as described above, when the liquid container 1 is used as an ink cartridge, the piezoelectric sensor 35 of the ink detection unit 11 can be effectively used as an ink end detection mechanism for detecting that an ink residual quantity in the ink pack 7 becomes zero.

Then, as shown in FIG. 2, if the liquid is absorbed from the ink supply port 9, the diaphragm 45 absorbs the liquid and the on/off valve mechanism 12 is closed. Accordingly, the inflow of ink from the ink pack 7 to the sensor chamber 21 is blocked by the on/off valve mechanism 12, and the sensor chamber 21 is in a negative pressure state. Then, a minute bubble 51 existing in the sensor chamber 21 shown in FIG. 1 is swelled and becomes a bubble 51A having a large volume, as shown in FIG. 2. Therefore, resistance of a flow of ink to be discharged from the ink supply port 9 increases, and the bubble 51A is easily transferred along with ink that flows toward the ink supply port 9.

According to the above-described liquid container 1 of this embodiment, the on/off valve mechanism 12 that is disposed between the ink pack 7 and the sensor chamber 21 so as to block the inflow of ink from the ink pack 7 to the sensor chamber 21 is provided. Accordingly, when the inflow of the liquid from the ink pack 7 to the sensor chamber 21 is blocked by the on/off valve mechanism 12, and the sensor chamber 21 is set in a negative pressure state through the suction of ink from the ink supply port 9, the minute bubble 51 existing in the sensor chamber 21 can be swelled and have a large volume.

Accordingly, resistance against the bubble 51A by the flow of ink to be discharged from the ink supply port 9 can increase, and the bubble 51A can be easily transferred along with ink that flows toward the ink supply port 9.

In a state where the minute bubble 51 is swelled, as shown in FIG. 3, if ink is supplied from the ink pack 7 to the valve chamber 41 by the pressurization of the ink pack 7 due to pressurized air to be supplied to the pressure chamber 3, the on/off valve mechanism 12 is opened, and ink flows into the sensor chamber 21. Therefore, the bubble 51A is discharged from the ink supply port 9 according to the ink flow. As a result, the minute bubble 51 existing in the sensor chamber 21 can be reliably discharged.

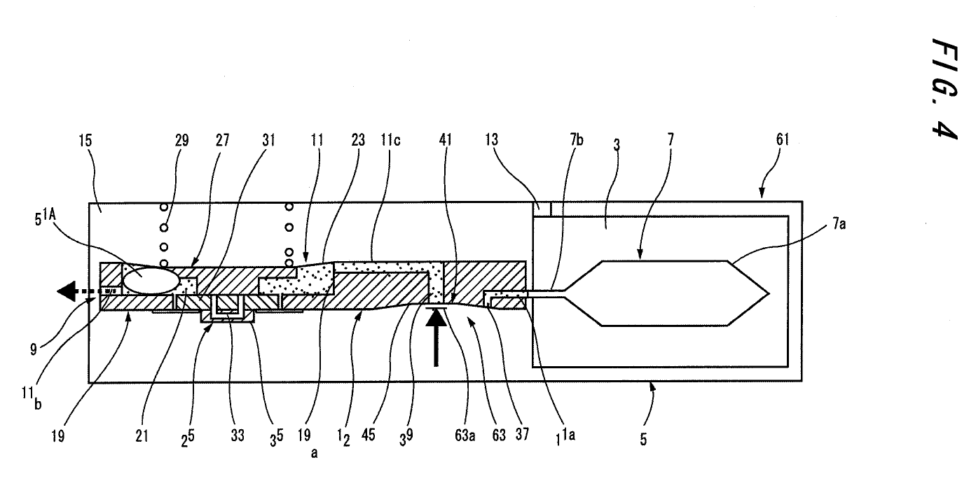

FIG. 4 is a longitudinal cross-sectional view of a liquid container according to a second embodiment of the invention.

A liquid container 61 of the second embodiment improves a part of the liquid container 1 shown in FIG. 1. Specifically, the diaphragm 45 defining the valve chamber 41 moves by a driving unit 63 that drives a plunger 63a with a fluid pressure or an electromagnetic solenoid.

That is, an external force is applied to the diaphragm 45. The movement of the diaphragm 45 may be performed by the driving unit 63 or by the cooperation of the external force of the driving unit 63 and the negative pressure according to the suction force from the ink supply port 9 in the above-described embodiment. Moreover, other parts are common to the liquid container 1 shown in FIG. 1. Therefore, the same parts are represented by the same reference numerals, and the descriptions thereof will be omitted.

According to the liquid container 61 of the second embodiment, the diaphragm 45 can be deformed by causing the external force from the driving unit 63 to act on the diaphragm 45 of the on/off valve mechanism 12. Then, the diaphragm 45 comes into close contact with the inlet port 37 and the outlet port 39 formed in the valve chamber 41 by the deformed diaphragm 45 and the negative pressure of the sensor chamber 21 according to the suction of ink from the ink supply port 9. Then, the on/off valve mechanism 12 can be more reliably closed.

The configurations of the liquid containing chamber, the liquid detection chamber, the detection unit, and the on/off valve mechanism in the liquid container of the invention are not limited to the configurations of the above-described embodiments. Various configurations can be adopted on the basis of the spirit of the invention.

For example, in the above-described embodiments, the compressed coil spring 29 is used as an urging unit that urges the flexible film 23 and the pressure receiving plate 27 toward the piezoelectric sensor 35.

However, instead of the compressed coil spring 29, an urging unit formed of a different elastic member may be used.

In the above-described embodiments, the time at which the pressure receiving plate 27 defines the detection space in cooperation with the ink guide path 33 is set to a state where ink of the ink pack 7 is completely exhausted. Then, the piezoelectric sensor 35 functions as an ink end detection mechanism for detecting that the ink residual quantity of the ink pack 7 becomes zero.

However, the time at which the pressure receiving plate 27 defines the detection space in cooperation with the ink guide path 33 may be set to a state where ink of the ink pack 7 is nearly exhausted (a state where a small amount of ink remains). In this case, the piezoelectric sensor 35 can be used as an ink near-end detection mechanism for detecting a state where the ink residual quantity in the ink pack 7 almost becomes zero.

In the liquid container of the invention, the concave portion serving as the vibration reaction region, in which the detection space is defined and to which the pressure detection unit applies the vibration is not limited to the ink guide path 33 shown in the above-described embodiments. The concave portion according to the invention may have a simple cutout shape to be formed at the top surface of the bottom plate 31, not a tubular path.

The use of the liquid container according to the invention is not limited to the ink cartridge of the ink jet recording apparatus. For example, the liquid container of the invention is used for various liquid consuming apparatuses having a liquid jetting head that ejects a minute amount of liquid droplet.

Specific examples of the liquid consuming apparatus having a liquid jetting head include an apparatus having a color material jetting head used in manufacturing color filters of a liquid crystal display or the like, an apparatus having an electrode material (conductive paste) jetting head used in forming electrodes of an organic electroluminescent (EL) display or a surface emission display (FED), an apparatus having a bioorganic compound jetting head used in manufacturing a bio-chip, an apparatus having a sample spraying head as a precision pipette, a textile printing apparatus, or a micro dispenser.

What is claimed is:

1. A liquid container comprising:
a liquid containing chamber that discharges a liquid stored therein by pressurization of a pressure unit;
a liquid detection chamber that is connected to the liquid containing chamber, and the volume of which changes according to an inflow amount of the liquid from the liquid containing chamber;
a detection unit for detecting a change of the volume of the liquid detection chamber; and
a valve mechanism that is disposed between the liquid containing chamber and the liquid detection chamber and that can block an inflow of the liquid from the liquid containing chamber to the liquid detection chamber.

2. The liquid container according to claim 1,
wherein the valve mechanism includes a valve chamber that communicates an inlet port communicating with the liquid containing chamber with an outlet port communicating with the liquid detection chamber, and a diaphragm that defines the valve chamber and is deformable by an external force, and
the outlet port that is formed in the valve chamber is closed by deformation of the diaphragm.

3. The liquid container according to claim 2,
wherein the valve mechanism is disposed in a region that is isolated from a pressure of the pressure unit, and the outlet port formed in the valve chamber is closed by the deformation of the diaphragm according to a negative pressure of the valve chamber generated through suction of the liquid from a liquid supply port.

4. The liquid container according to claim 3,
wherein the outlet port that is formed in the valve chamber has an area larger than that of the inlet port that is formed in the valve chamber.

5. The liquid container according to claim 2,
wherein the outlet port that is formed in the valve chamber is disposed to face a maximum displacement portion of the diaphragm.

6. The liquid container according to claim 1,
wherein the liquid detection chamber is configured by sealing an opening of a concave space provided in a member forming the liquid detection chamber with a film that is deformable according to a liquid containing amount.

7. The liquid container according to claim 1,
wherein the diaphragm is formed of a deformable film that seals an opening of a concave place provided in a member forming the valve chamber.

8. The liquid container according to claim 1,
wherein the detection unit includes a moving member that is accommodated to move according to the liquid containing amount of the liquid detection chamber, a concave portion that, if the liquid containing amount of the liquid detection chamber becomes a predetermined amount or less, defines a detection space in cooperation with a surface of the moving member, and a piezoelectric detection unit that applies vibration to the concave portion and detects a free vibration state according to the applied vibration.

9. A liquid container comprising:
a pressure chamber in which a pressurized fluid can be introduced;
a liquid containing chamber that discharges a liquid stored therein by the pressurized fluid introduced into the pressure chamber;
a liquid detection chamber that is connected to the liquid containing chamber, and the volume of which changes according to an inflow amount of the liquid from the liquid containing chamber;
a detection unit for detecting a change of the volume of the liquid detection chamber; and
a flexible member that defines at least apart of a flow passage connecting the liquid containing chamber and the liquid detection chamber to each other and can block the flow passage according to a difference of pressure between the liquid containing chamber and the liquid detection chamber.
